(19) United States
(12) Patent Application Publication
(10) Pub. No.: US 2016/0019297 A1
(43) Pub. Date: Jan. 21, 2016

(54) METHOD AND APPARATUS FOR CLONING A TARGET LIST

(71) Applicant: DATAGENCE INC., Red Bank, NJ (US)

(72) Inventors: Bradley Mack, Winston Salem, NC (US); David B. Wirsching, III, Blue Bell, PA (US); Christopher S. Alewine, Annapolis, MD (US)

(21) Appl. No.: 14/525,447

(22) Filed: Oct. 28, 2014

Related U.S. Application Data
(60) Provisional application No. 62/024,992, filed on Jul. 15, 2014.

(51) Int. Cl. G06F 17/30; G06N 7/02

(52) U.S. Cl. CPC G06F 17/30864; G06N 7/02

(57) ABSTRACT

A computing device (e.g., a server or other type of computer) electronically receives multiple target records from a client and determines which records of the target list matches records of a database. The matched records of the database include one or more additional fields that are not contained in the target records received from the client. The computing device models the relationship among the matched records of the database with respect to the one or more additional fields. In one implementation, the computing device carries out this modeling by performing stepwise linear regression on the matched records of the database with respect to the one or more additional fields. The computing device uses the output of this modeling process in order to identify which of the one or more additional fields has a significant impact on the matching between the records of the target list and the records of the database.

### TECHNICAL FIELD

The present disclosure is directed to database record analysis and, more particularly, to methods and an apparatus for cloning a target list.

### BACKGROUND

Identifying the right target market is a challenge for all businesses. If a business survives past the first few years, it typically does so by building and maintaining a core group of loyal customers. For the business to grow, however, it needs to expand beyond that core group of customers. Finding out what sort of profile a business' “best” customers fit is an important goal of marketers. Put another way, a business would ideally like to “clone” its best customers.

One of the challenges in attempting to find clones of the best customers is that a business does not necessarily know which traits are predictive of a prospective customer becoming a “best customer.”

### DRAWINGS

While the appended claims set forth the features of the present techniques with particularity, these techniques may be best understood from the following detailed description taken in conjunction with the accompanying drawings of which:

FIG. 1 is a block diagram of a computing device according to an embodiment;

FIG. 2 is a block diagram showing the software architecture according to an embodiment;

FIG. 3 through FIG. 18 are web pages used in various embodiments;

FIG. 19 is a message sequence diagram illustrating the interaction between the different components of FIG. 2 in an embodiment;

FIG. 20A and FIG. 20B depict a table of five records in a database, with FIG. 20A showing the leftmost fields and continuing on to FIG. 20B, which shows the rightmost fields; and

FIG. 21 through FIG. 23 depict tables of records used to illustrates various embodiments.

### DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

As used herein, “client” refers to an entity (business or individual) that is accessing a system (e.g., via a web interface) on which various methods described herein may be carried out. The term “target” as used herein refers to the client's current customer or prospective customer, which could be an individual person or a business. “Target list” refers to a list of the client's targets (sometimes referred to as a “customer list,” or “mailing list,” or “marketing list”). The term “clone” or “cloned record” as used herein refers to a record that has been determined, based on one or more of the methods described herein, to have a high potential to be useful to the client. Customers or potential customers whose records fit this criterion are sometimes referred to as “high opportunity” customers. A set of such cloned records is referred to herein as a “cloned list.” The cloned list, which is provided to the client, can be thought of as containing contact information for businesses or individuals that are “clones” (in a marketing sense) of the client's customers—i.e., the individuals or businesses have profiles that are similar to those of the target list provided by the client.

The present disclosure describes a method for cloning a target list. According to various embodiments, a computing device (e.g., a server or other type of computer) electronically receives multiple target records from a client and determines which records of the target list match records of a database. The matched records of the database include one or more additional fields that are not contained in the target records received from the client. The computing device models the relationship among the matched records of the database with respect to the one or more additional fields. In one embodiment, the computing device carries out this modeling by performing stepwise linear regression on the matched records of the database with respect to the one or more additional fields. The computing device uses the output of this modeling process in order to identify which of the one or more additional fields has a significant impact on the matching between the records of the target list and the records of the database. The computing device then scores the matched records of the database based on those fields (of a preselected set of fields) that have been identified to have a significant impact on the matching. In one embodiment, the computing device carries out this scoring process by assigning values, based on the modeling, to a reference table of the matched records, and then scoring the records of the database based on the results of the modeling. Based on the scoring of the records of the database, the computing device selects records of the database to offer to the client.

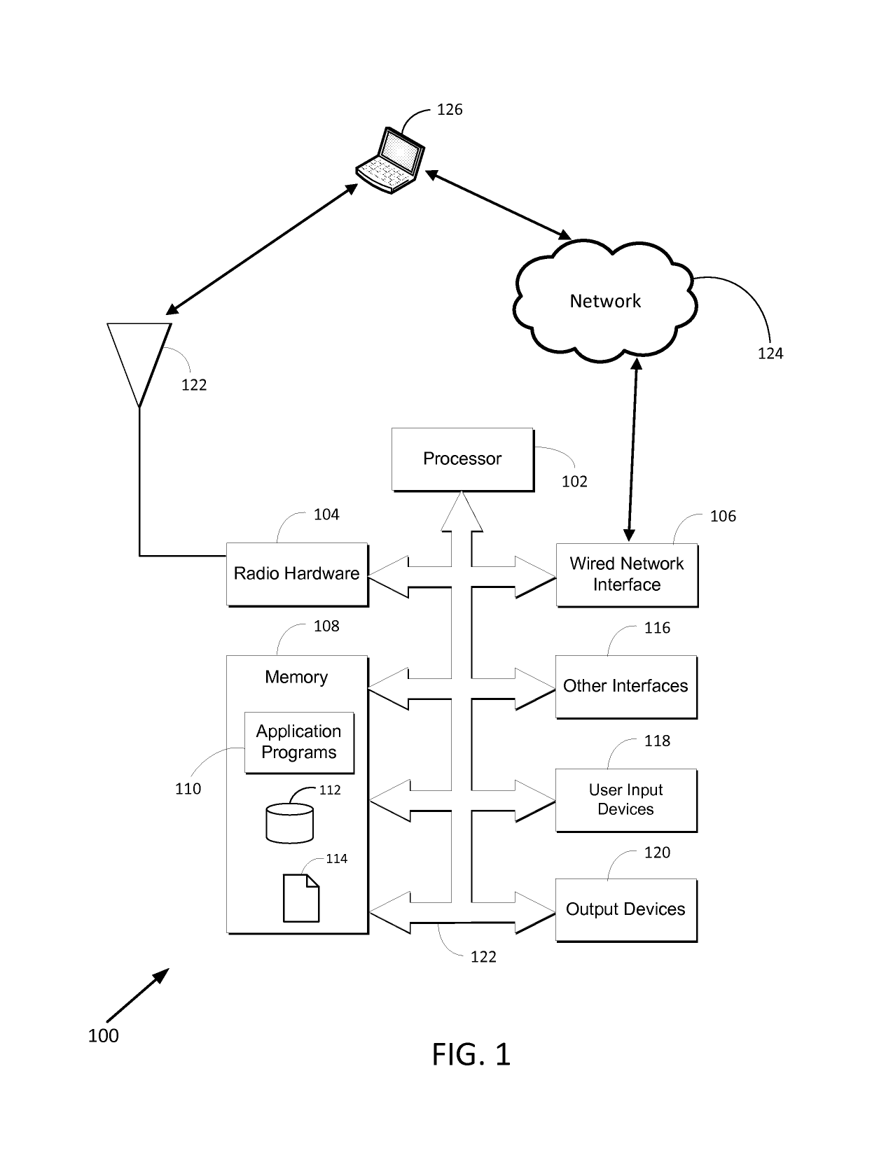

Turning to FIG. 1, a computing device 100 (“the device 100”) capable of carrying out the various embodiments described herein is shown in one configuration and includes a controller or processor 102, radio hardware 104 (e.g., a baseband chipset or WiFi chipset that includes a transceiver capable of communicating by radio according to a wireless protocol), a wired network interface 106 (such as an Ethernet card), and other interfaces 116 (such as a universal serial bus interface). The device 100 further includes a memory 108, in which application programs 110, databases 112, and files 114 are stored. The device 100 also includes user input devices 118 (e.g., a keyboard, a touchscreen, and a microphone), output devices 120 (e.g., a liquid crystal display and a speaker), and an antenna 122. The memory 108 can be implemented as volatile memory, non-volatile memory, or a combination thereof. The memory 108 may be implemented in multiple physical locations and across multiple types of media (e.g., dynamic random access memory plus a hard disk drive). The memory 108 can also be split among multiple hardware components. In one embodiment, the processor 102 has a separate memory (e.g., level 1 cache and registers), which is represented by the memory 108. The processor 102 retrieves instructions (including those of the application programs 110) from the memory 108 and operates according to those instructions to carry out various functions, including providing outgoing data to and receiving incoming data from all of the other components of the device 100. Thus, when this disclosure refers to any of the application programs 110 carrying out an action, it is, in many embodiments, the processor 102 that actually carries out the action (in coordination with other pieces of hardware of the device as necessary).

In an embodiment, the device 100 is communicatively linked to a network 124, such as the internet, via the wired network interface 106 or the antenna 122, and interacts with a client device 126.

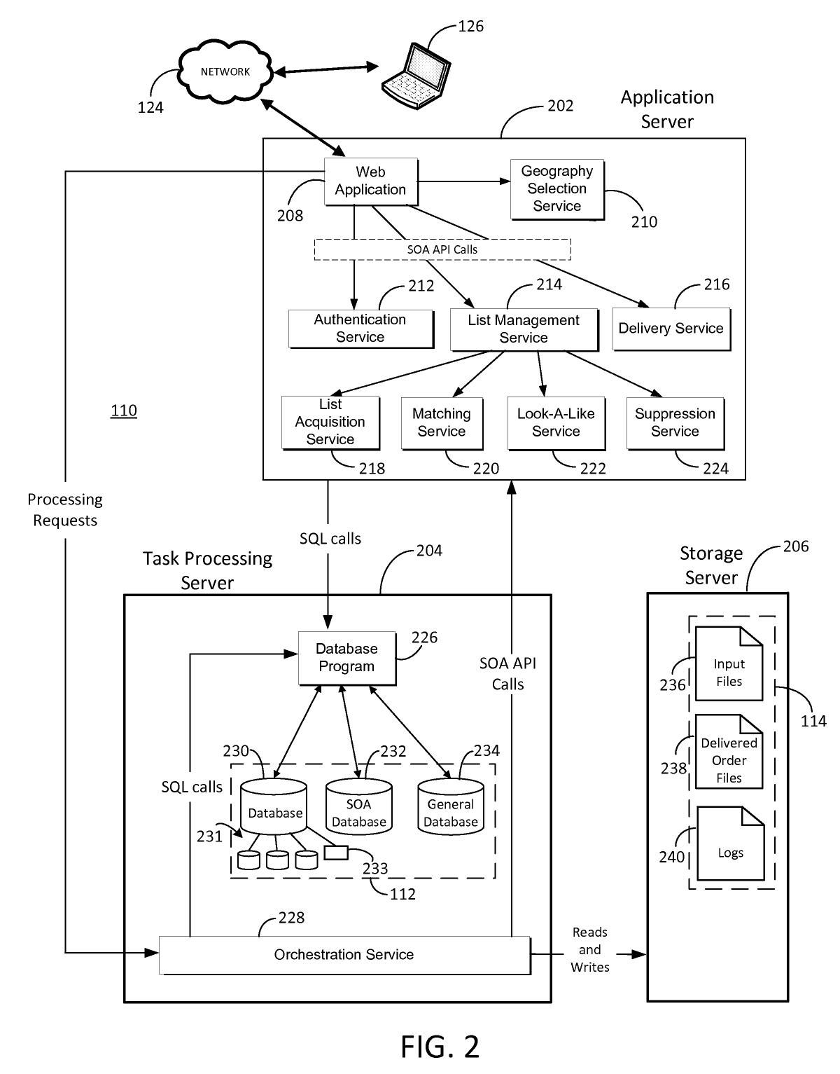

Turning to FIG. 2, in an embodiment, the application programs 110 executed by the device 100 include an application server 202, task processing server 204, and a storage server 206. In one embodiment, each of these three servers is executed on a separate computing device. As noted previously, when these application programs carry out functions, it is, in many embodiments, the processor 102 that actually performs the functions.

The application server 202 includes a number of application programs, also referred to as “programs,” “applications,” or “services.” The application server 202 includes a web application 208. In an embodiment, the web application 208 is Microsoft® Internet Information Services component that interacts with the other application programs of the application server 202 via the Microsoft® Service Oriented Architecture (“SOA”) through the use of one or more application program interfaces (“APIs”). When a user (e.g., an employee of the client) of the client device 126 interacts with the web application 208, the web application 208 transmits one or more web pages (examples of which will be discussed below). During interaction with these web pages, the user identifies (and uploads, if appropriate) a target list to be cloned. The web application 208 is capable of calling the following services: a geography selection service 210 to allow a user to limit the search for matches to certain geographical limits, an authentication service 212 to authenticate users who attempt to access the application server 202, a list management service 214, and a delivery service 216 to deliver purchased lists to the client device 126.

In an embodiment, the list management service 214 calls a list acquisition service 218 to carry out functions relating to obtaining the target list from the client (e.g., uploaded by the user), a matching service 220 to carry out functions relating to identifying matches between records of the target list and records of a database, a look-a-like service 222 to perform statistical analyses on those records of the database that have been identified as a result of the matching process and score all the records of the database based on the results of the statistical analyses. The list management service also calls a a suppression service 224 to exclude those records of the database that the client has previously purchased.

The task processing server 204 includes a database program 226 and an orchestration service 228. The database program 226 manages a database 230, an SOA database 232, and general database 234. In one embodiment, the database program 226 is Microsoft® SQL Server. The records of the database 230 are organized into a number of datamarts 231. Each datamart 231 contains records that are appropriate for a particular market segment or for a particular type of marketing. For example, there may be consumer datamart that contains names, addresses, etc. of individual consumers, and a business data mart that contains the names, addresses, etc. of businesses. In some datamarts, the records contain postal addresses of targets, but not email addresses. Such datamarts are referred to herein as “postal datamarts.” In other datamarts, the records may contain both email addresses and postal addresses. Such datamarts are referred to herein as “e-postal datamarts.” For example, there may be a postal consumer datamart and an e-postal consumer datamart. Each datamart can be treated as a separate database, although some records may be members of multiple datamarts.

In an embodiment, each record of the database 230 has a numeric value assigned to it, referred to herein as a “match key.” The match key is generated based on the content of two or more fields of the record. As a result, the match key for each record of the database 230 is unique with respect to the fields of the record on which the match key is based. In one embodiment, fields having similar but not identical content—i.e., they “match” according to a fuzzy logic matching process—may be assigned the same numeric value. For example, a record having a “first name” field containing the string “Jon” and a record whose “first name” field contains the string “Jonathan” may be fuzzy logic-matched. By standardizing the name as “Jonathan,” the two records end up with the same numeric value for the “first name” field. The numeric values of all of the fields on which the match key is based are combined (e.g., concatenated) to yield the overall match key for a record. Thus, for example, two records having the same (or fuzzy logic-matched and standardized) content in those particular fields will end up with the same match key value. The content of other fields (i.e., fields that are not accounted for in the generation of match keys) do not impact the overall match key value of a record.

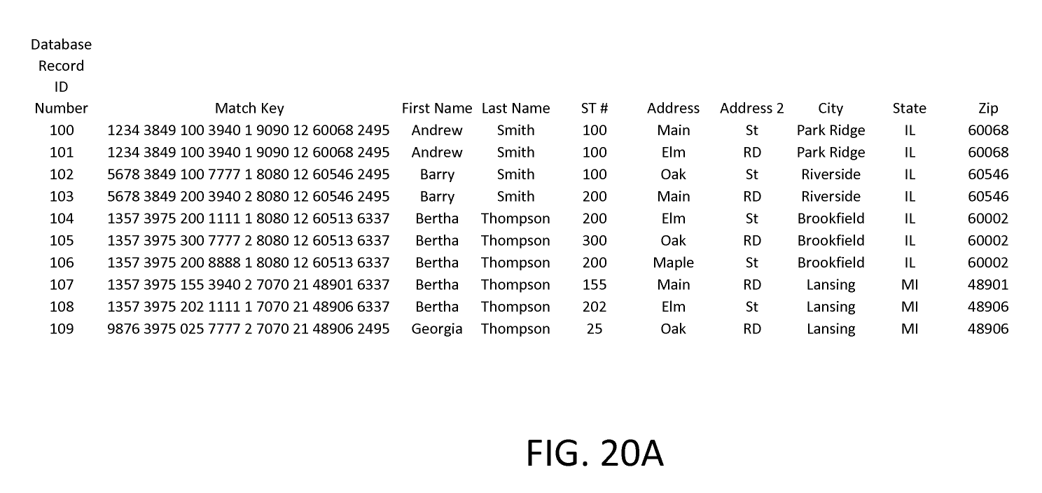

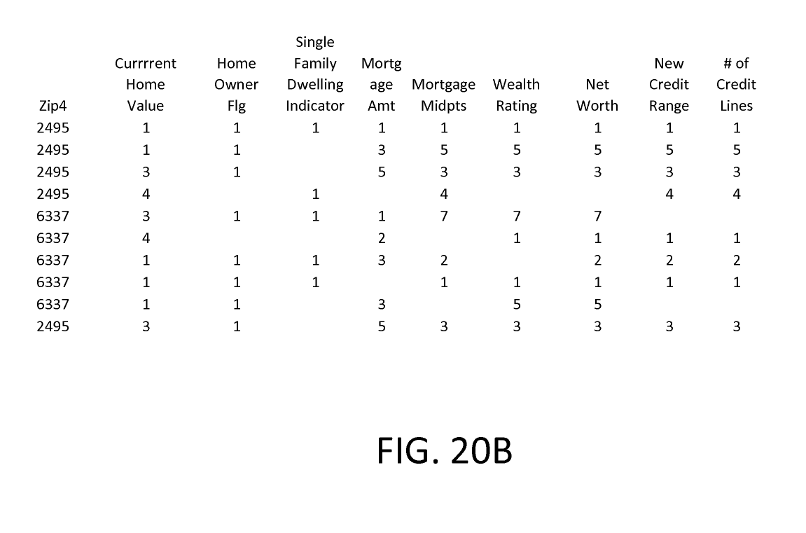

To illustrate, assume that the database 230 contains records of individual consumers, with each record having the fields depicted in the table shown in FIGS. 20A and 20B. Further assume that the match key is generated as follows: (1) Carry out fuzzy logic-matching of the fields that are going to be used for the overall record matching that will eventually occur. In this example, assume that the fields that will be used for matching are the First Name, Last Name, ST #, Address, Address 2. City, State, Zip, Zip4. (2) Standardize the fields that are fuzzy logic-matched (e.g., convert Jon to Jonathan and converts Dr. to Drive). (3) Hygiene process the fields (e.g., eliminate duplicates). (4) Convert the string of text in each of the First Name, Last Name, ST #, Address, Address 2. City, State, Zip, Zip4 fields into numeric values. For example, in FIGS. 20A and 20B, those fields that are already numeric values stay as they are, while those that are not already in numerical form are assigned a unique, random value (e.g., Andrew is assigned 1234, Smith is assigned 3849. (5) Append the fields together, resulting in the match key (shown in FIG. 20A for each record). The match key for each record of the database 230 generally remains constant (assuming the record does not change) and may be thought of as a static key.

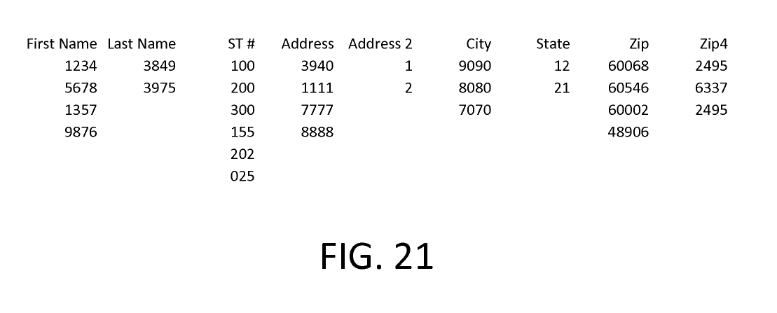

In an embodiment, the matching keys of the records of the database 230 are used to create a table 233. FIG. 21 depicts an example of the matching keys of the records of the table of FIGS. 20A and 20B converted to a table. Note that the table of FIG. 21 is smaller than the table of FIG. 20A and FIG. 20B. Extrapolating this to a larger scale results in a very significant reduction in the size for large datasets. For example, for a database having a records of a significant portion of consumers in the United States, carrying out the optimizations—fuzzy logic-matching, standardization, and hygiene processing—can reduce the number of records against which an incoming list of target records needs to be matched by millions, resulting in a significantly reduced amount of time needed by the computing device 100 to carry out the matching processes described herein and result in a significantly reduced use of the memory 108 by the computing device 100 (as compared to carrying out matching without these optimizations). Furthermore, representing each field of the records with numeric values (e.g., integer values) as described above may also result in a significantly reduced amount of time needed by the computing device 100 to carry out the matching processes described herein and result in a significantly reduced use of the memory 108 by the computing device 100 (as compared to carrying out matching without converting to numeric values).

The storage server 206 stores input files 236, delivered order files 238, and log files 240. The input files 236 include the target list uploaded from the client device 126. The delivered order files 238 include the cloned list that is eventually delivered to the client device 126. The log files 240 include logs of events and errors that occur.

In an embodiment, the orchestration service 228 orchestrates the background processing required by the web application 208. The orchestration service 228 carries this function out by making the necessary API calls to the list management service 214, the authentication service 212, and the delivery service 214. The orchestration service 228 also handles the re-try logic for processing that fails. Furthermore, the orchestration service 228 is responsible for following the workflow for the web application 208. The orchestration service 228 follows the workflow by setting and updating the steps of a draft or an order, and relaying the progress percentages (when known) provided by the list management service 214. In one embodiment, the orchestration service 228 is a Microsoft® Windows® Communication Foundation (“WCF”) service hosted inside a Microsoft® Windows® service, and the web application 208 sends processing requests to the orchestration service 228 as asynchronous WCF calls.

According to an embodiment, the web application 208 acts as the front end to the client device 126, takes input from the client device 126, and forwards requests for processing to the orchestration service 228. The web application 208 waits until the processing is done and then displays the results. The orchestration service 208 triggers the required operations of the list management service 214 in the proper sequence, waits for those operations to finish, and validates the output of the operations. The orchestration service 228 sends information to the web application 208 via the database 230 by updating and reading status flags of the current project or order.

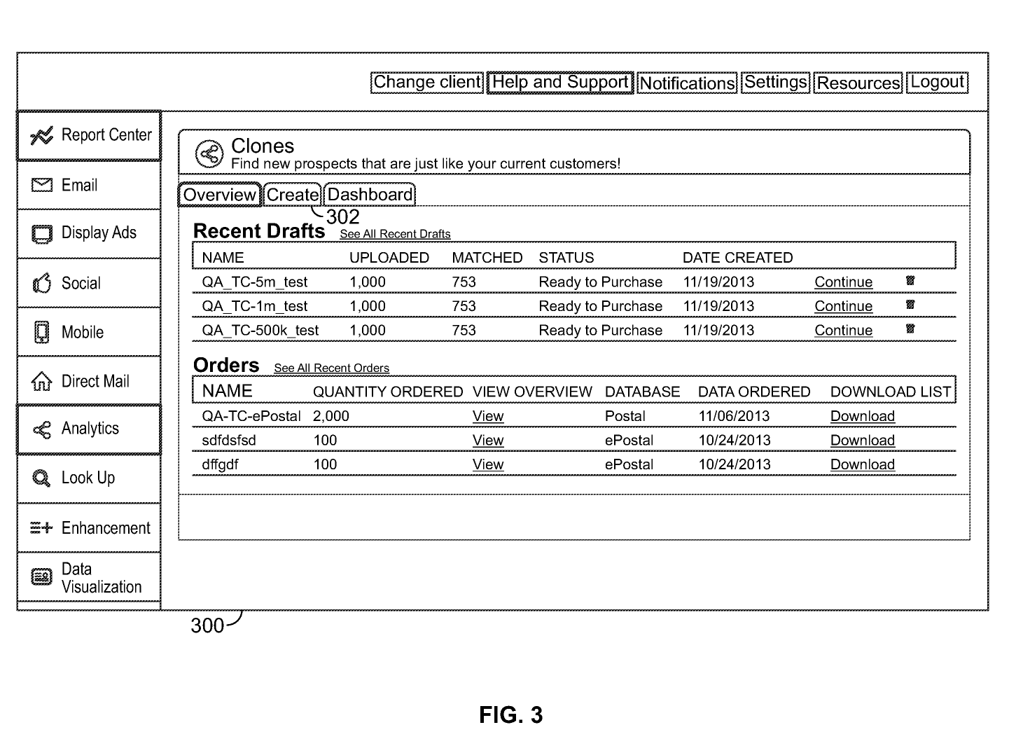

When the client device 126 initially accesses the web application 208 in an embodiment, the web application 208 transmits an overview page to the client device 126, an example of which is depicted in FIG. 3. The overview page 300 shows a summary of the client's latest activity. In this example, the newest three drafts and three orders are shown. From here, a user can continue a previously-begun draft. The last three created orders are also shown, allowing the user to download a previously-created target list again, or view statistics on it. There are links to each section that take the user to a full list of drafts and orders.

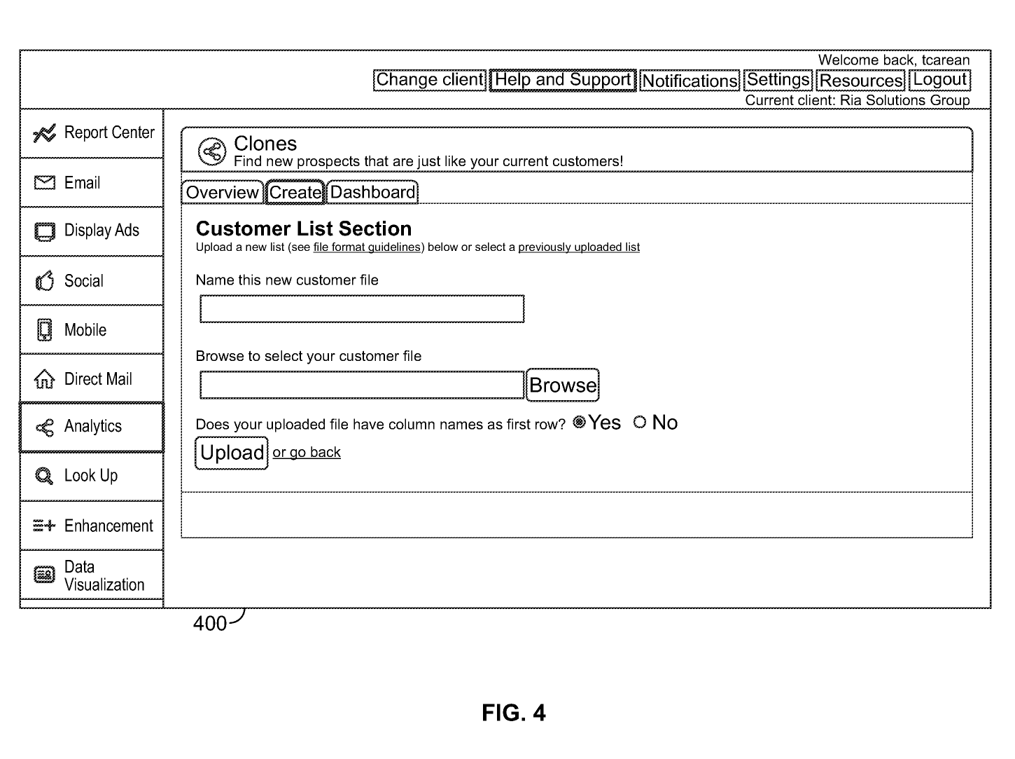

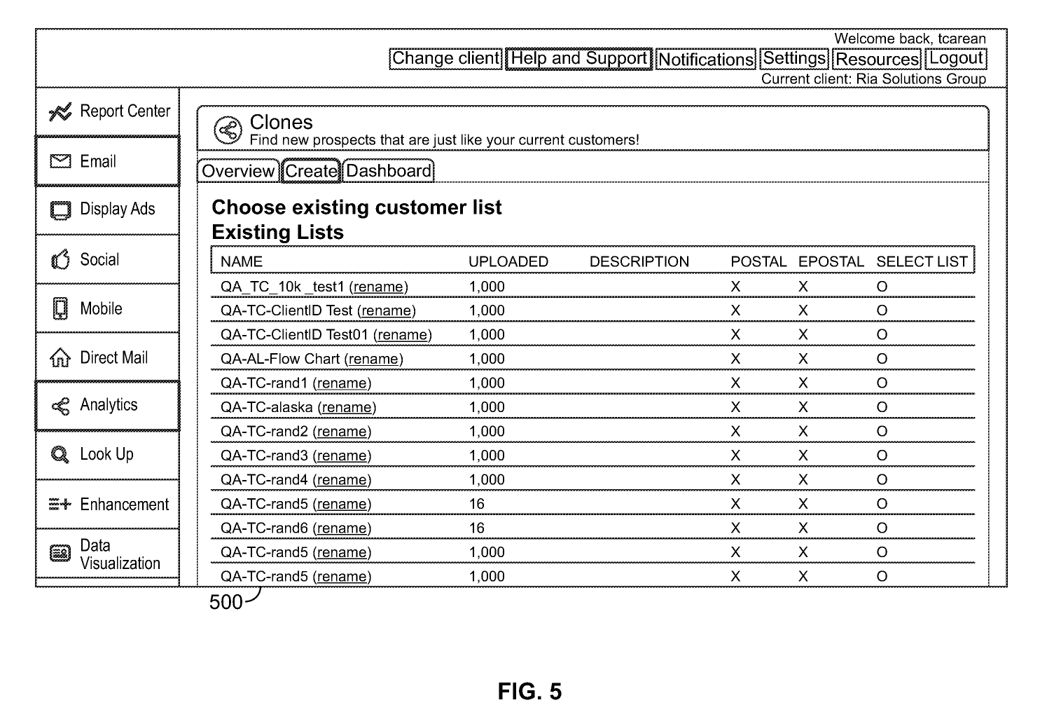

In an embodiment, when the user clicks a “Create” tab 302, the web application 208 transmits a list selection page to the client device 126, an example of which is depicted in FIG. 4. The list selection page 400 allows the user to create a new clone project. To do so, the user chooses a name for the project and defines the target list. From the client device 126, the user can upload a file (e.g., in the form of a comma-separated value (“CSV”) or tab-delimited file) containing a list of targets and give the uploaded list a name so that the user can re-use it later. Alternatively, the user can click on the “select a previously uploaded list” link, in which case the web application 208 transmits an existing target list page, an example of which is shown in FIG. 5 (reference numeral 500). When uploading a file, the user may indicate whether or not the file contains headers. This way, the list acquisition service 218 will know that the first line is not an actual target (e.g., not an actual individual or business). The list acquisition service 218 may also use the header to detect what kind of information a particular column contains.

An example of a CSV input file containing a (small) target list is the following:
“FirstName”,“LastName”,“MiddleName”,“State”,“ZipCode”,“City”,“Address1”,” Address2″
“John”,“Doe”,“”,“MI”,“48188”,“Canton”,“25 River Woods Dr”,“”
“Jane”,“Doe”,“”,“MI”,“48184”,“Wayne”,“3120 Van Born Rd Apt 3”,“”
“John”,“Johnson”,“”,“MI”,“48188”,“Canton”,“2175 Yarmouth Ct”,“”
“Alex”,“Stanley”,“”,“MI”,“48141”,“Inkster”,“320 Tobin Dr Apt 200”,“”“Edward”,“Kings”,“”,“MI”,“48124”,“Dearborn”,“150 S Silvery Ln”,“”
   The column order and naming does not matter, as long they are unique. After the user uploads the file, the user will be able to map each column to the correct fields.

Continuing with FIG. 5, the existing target list page 500 also indicates how a target list can be used. The content of a target list may dictate what kind of datamart the target list can be matched against. For example, a client may not be able use a postal datamart to clone a target list containing only email addresses because the records of a postal datamart do not contain email addresses. From the existing target list page 500, the user can also rename lists. If the user clicks on a “rename” link, a popup will appear, asking for a new name. After the rename is complete, a popup message confirming this will appear.

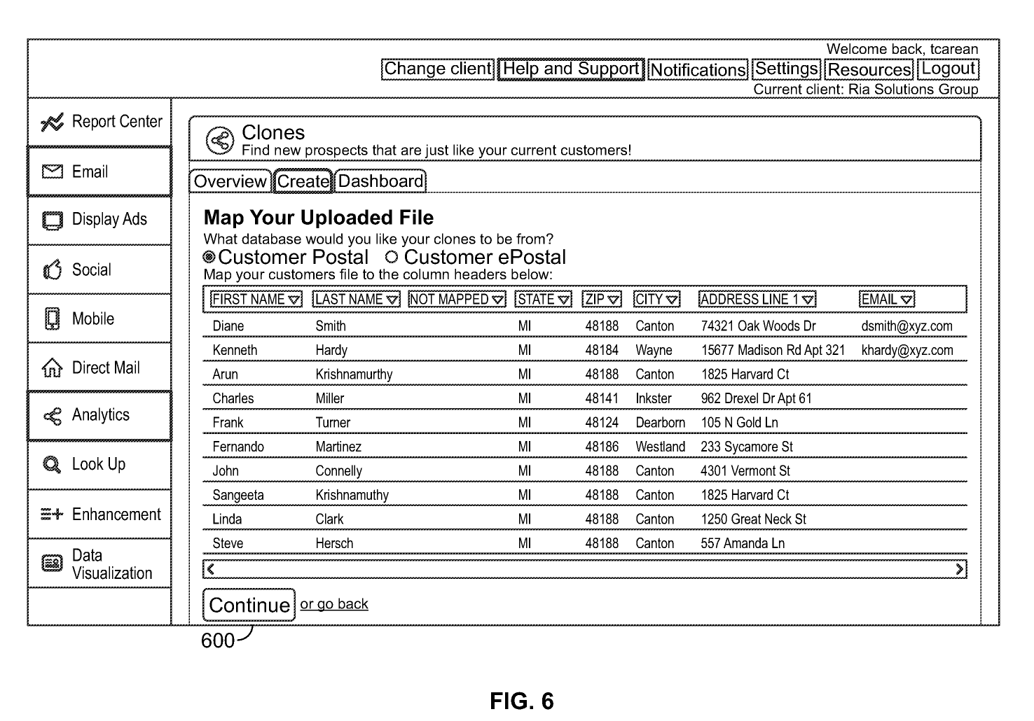

If the user has uploaded a target list, in an embodiment, the web application 208 transmits a column mapping page to the client device 126, an example of which is shown in FIG. 6. The user interacts with the column mapping page 600 to map the columns of the file containing the target list (one of the input files 236) to defined pieces of information in order to indicate which field is the first name, which is the last name, which is the ZIP code, etc. If the input file 236 contains headers, an auto-detection feature maps most of the fields automatically, only requiring the user to validate the selection or to make an occasional column change in the event that a column was not properly auto-detected.

For example, in order to match against a postal datamart, the following fields may be required:

First Name

Last Name

Zip Code

Address

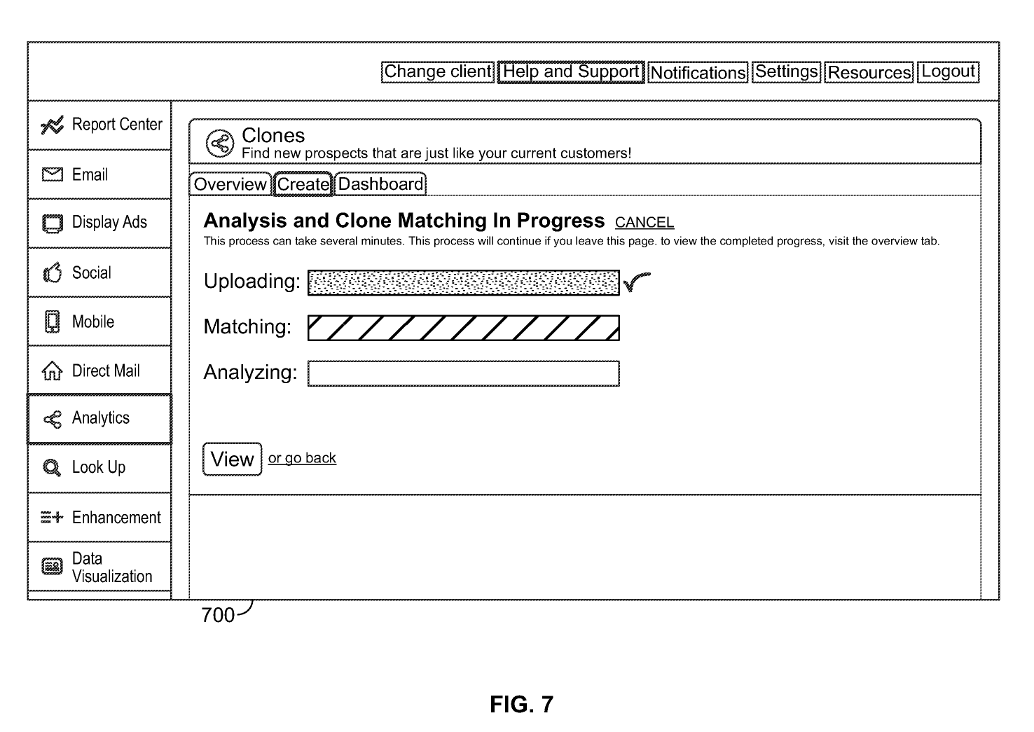

When matching against an e-postal datamart, the user may be required to select the same set of fields as for the postal records, or if the uploaded file also contains emails, it may be sufficient for the user just to map the Email field. When the user is finished mapping the columns of the uploaded target list file, the user clicks the “Continue” button. Turning to FIG. 7, in an embodiment, the data web application 208 then transmits a progress page 700 to the device 126. While the progress page 700 is being displayed, the list management service 214 calls the matching service 220, which carries out a matching process, in which the matching service 220 attempts to match the target list against the records of the datamart selected by the user.

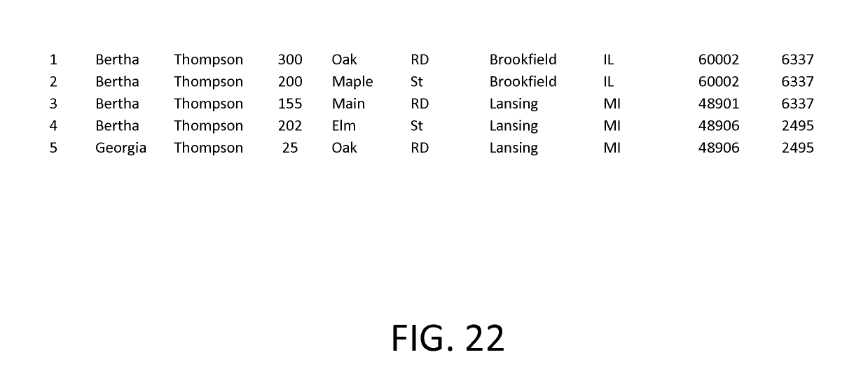

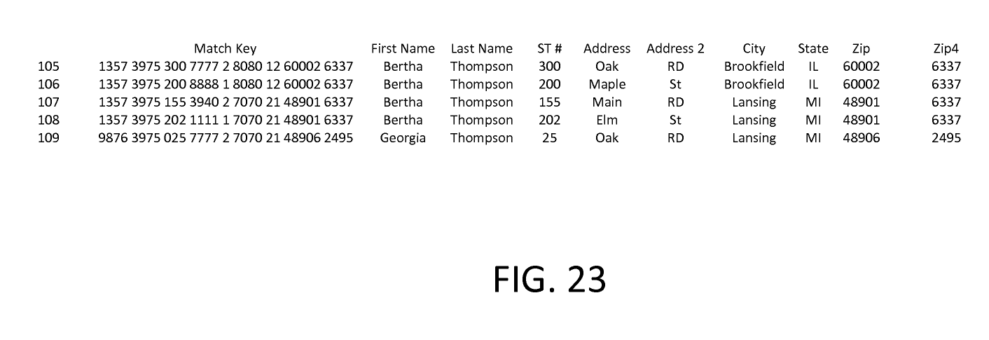

To carry out the matching process in an embodiment, the matching service 220 generates a match key for each of the records of the target list using the technique described above. For example, assume that the target list includes the records of the table shown in FIG. 22. For each record, the matching service 220 assigns a code to each field (e.g., the code for Bertha is 1357) as shown in FIG. 23. The matching service 220 then takes the created match key and compares the match keys to those of the database 230. For example, using the first record of FIG. 22 and matching against the records of the table of FIG. 21, the matching service 220 determines whether there is a 1357 for the first name field in the table of FIG. 21. The matching service 222 then goes to the next field, which is 3975, and determines whether 3975 is in the table of FIG. 21 for the last name field. It continues through this process. The matching service 222 deems a “match” to have occurred if a predetermined number or percentage of the fields of the match key of the target list record match the corresponding fields of the match key of the record of the datamart 231 (e.g., using the table of FIG. 21 to perform the actual match). Once all of the records of the target list have been put through the matching process, the matching service 220 assigns, to each record of the target list for which a match was found, the record ID of matching record of the datamart 231. For example, the first uploaded record of FIG. 22 has been assigned the record ID number 105, as it was deemed to have matched record number 105 (from FIGS. 20A and 20B) of the selected datamart 231 of the database 230.

The list management service 214 then calls the look-a-like service 222, which analyzes those records of the selected datamart 231 that matched one or more records of the target list to obtain an initial assessment of what the output of the final cloning process may look like. These operations may take time, so the progress page 700 displays a set of progress bars as well as checkmarks showing which operations are running and which are already completed.

When the processing is done, the “View” button is enabled, allowing the user to view some results. The user does not have to stay on this page to wait until the processing is finished. The user may instead return to access the results page later from a dashboard, which will be discussed below in more detail. The progress page 700 also gives the user the possibility to change the target file, change the mapping, or cancel the operation. To do so, the user clicks the “go back” or “cancel” link, which sends the user back to the column mapping page 600.

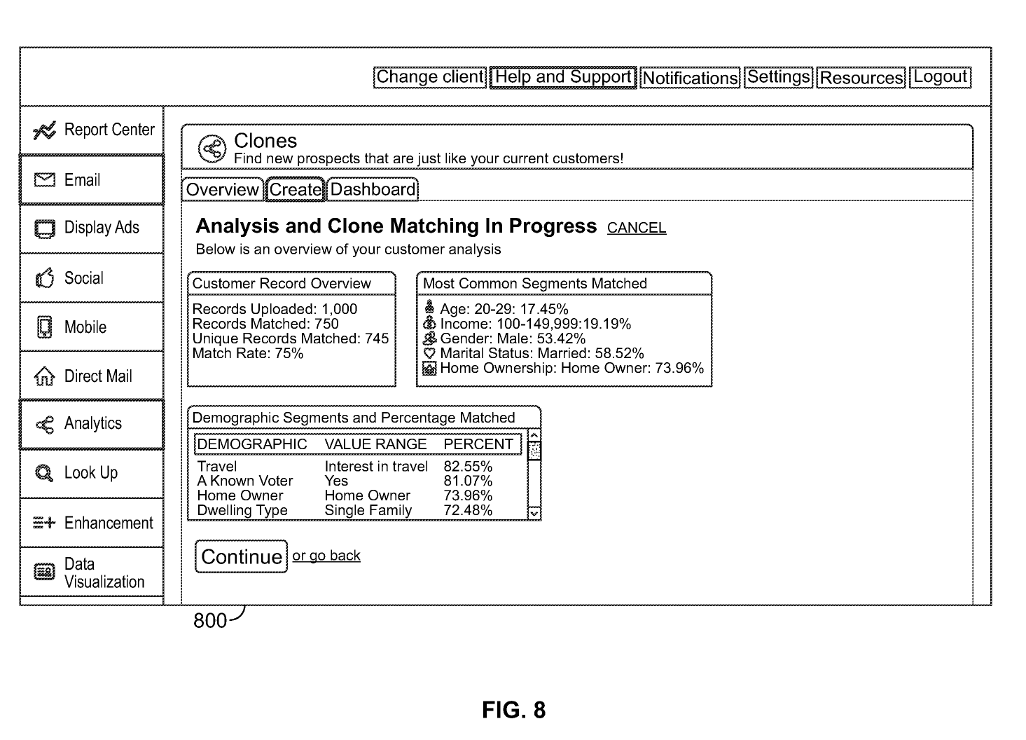

Once the matching and analysis processes are complete, the web application 208 transmits an analysis snapshot page to the client device 126, an example of which is shown in FIG. 8. The analysis snapshot page 800 shows a brief summary of the most important marketing segments for the uploaded target list (determined based on the analysis described above). The panel on the left shows how many records were uploaded, how many were matched in the selected datamart and how many were unique targets (e.g., unique individuals). The web application 208 displays a match rate that was calculated based on this information. The “Most Common Segments Matched” section shows a few important and most common market segments, determined by the highest percentage in the attribute distribution of the matched targets. The “Demographic Segments and Percentage Match” section shows all the market segments for the attributes taken into consideration by the look-a-like service 222 when the look-a-like service 222 identifies clones, sorted by percentage. In this particular example, these attributes are the following:

1) A Known Voter

2) Interest in travel

3) Dwelling Type

4) Home Owner

5) Book Buyer

6) Owns Stocks And Bonds

7) Presence Of Children

8) Marital Status

9) Political Affiliation

10) Gender

11) Generations in Household

12) Number Of Children In Household

13) Number Of Credit Lines

14) Education Level

15) Net Worth

16) Internet Buyer

17) Age

18) Number Of Persons In Household

19) Wealth Rating

20) Income

21) Length Of Residence

22) Interest in pets

23) Race/ethnicity

24) Small Office, Home Office Business

25) New Credit Range

26) Current Home Value

27) Mortgage Amount In Thousands

28) Mail Donor

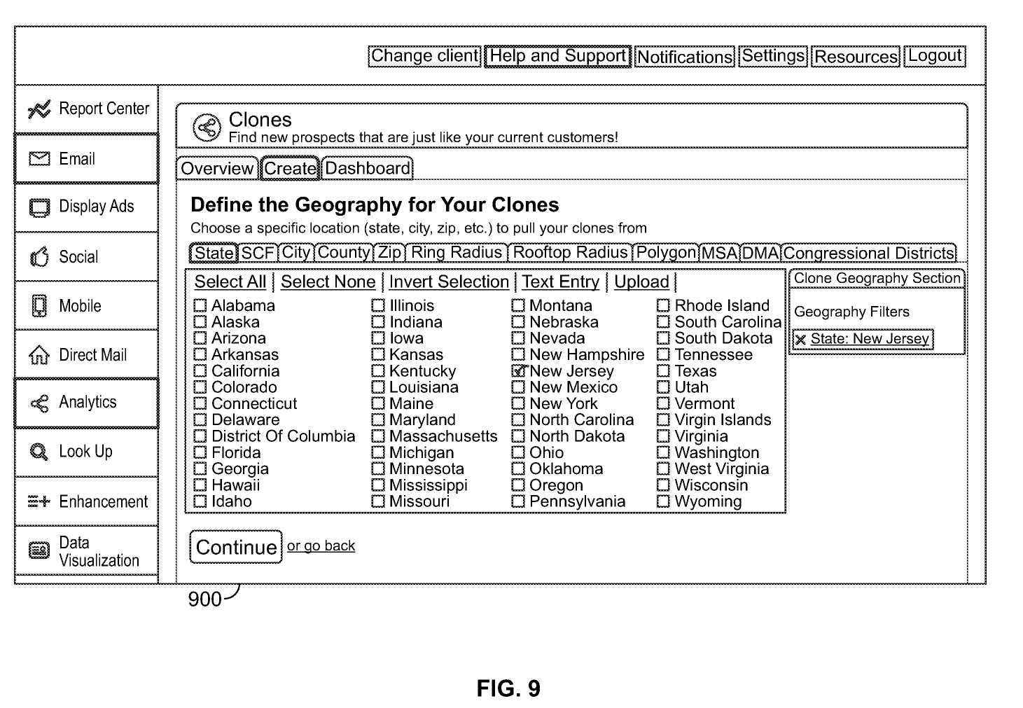

When the user clicks the “Continue” button on the analysis snapshot page 800, in an embodiment, the web application 208 transmits a geography definition page to the device 126, an example of which is shown in FIG. 9. The geography definition page 900 allows the user to define the geography for the cloning process. In other words, before starting the cloning process, the user defines the geographic area in which the client wants to look.

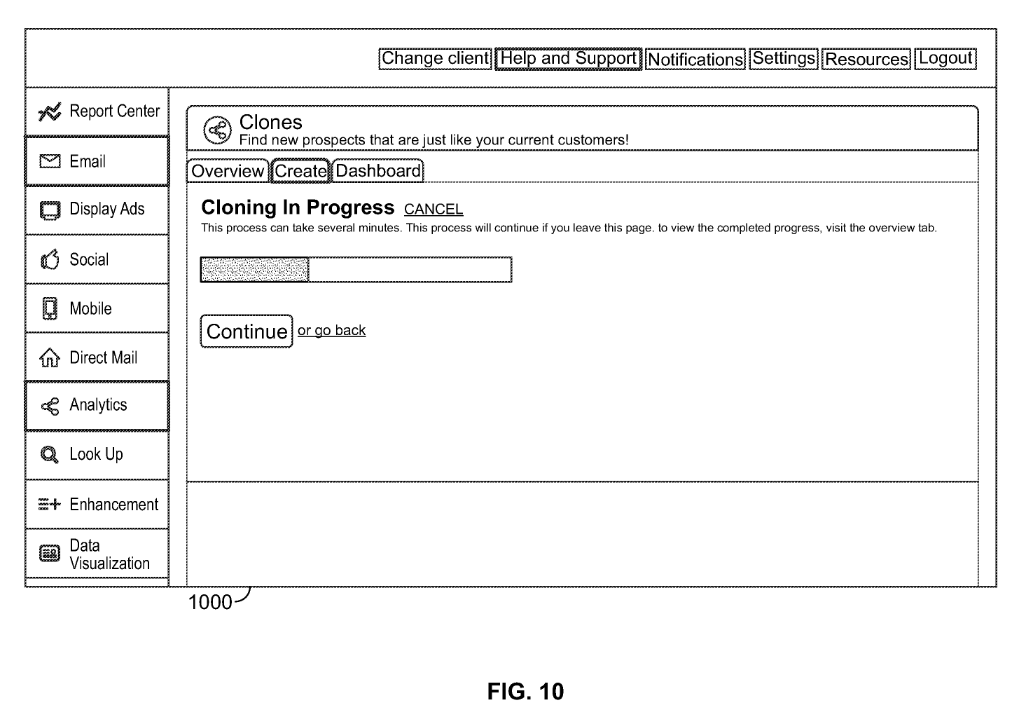

When the user clicks the “Continue” button on the geography definition page 900, in an embodiment, the web application 208 transmits a cloning progress page to the device 126, an example of which is shown in FIG. 10. The cloning progress page 1000 indicates to the user that cloning is in progress. Unlike other operations where progress may not be precisely measured (other than to know if it is complete or not), the cloning operation can determine how many clones have already been generated and roughly how many can be generated. Knowing these two pieces of information allows the web application 208 to display an accurate progress bar. This is helpful because, unlike matching, which may be executed quickly due to working with a relatively small input list (i.e., the target list uploaded by the user), the cloning process takes, as an input list, records from the whole selected target area, which could possibly be all of the records of the selected datamart (e.g., in the entire United States).

The list management service 214 then calls the look-a-like service 222, which does the following. For each record of the datamart 231 that was deemed to have been a match for a target list record, the look-a-like service 222 runs a mathematical modeling process. In one embodiment, the modeling process is a stepwise linear regression process. The modeling process helps to determine which attributes are most likely to result in good clones for the records of the target list. For example, the look-a-like service 222 may determine, based on the modeling process, that the most important attribute for the kind of consumers represented by the client's target list is political affiliation. The look-a-like service 222 may determine that the second most important attribute is the consumer's income level and the third to be the consumer's home ownership. Continuing with this example, those records of consumers having the most correlative political affiliation (e.g., “Democrats”) would receive a certain number of points, those having the most correlative income level (e.g., below $50,000 per year) will receive a certain number of points (weighted less than political affiliation), and those having the most home ownership status (e.g., renters) would receive a certain number of points (weighted less than political affiliation and income level).

The look-a-like service 222 then scores the records of the datamart 231 based on the outcome of the modeling process. The highest scoring records (e.g., by percentage, such as the highest 20%, or by number, such as the one thousand highest scoring records) are the ones that will be eventually be offered to the client as a cloned list. In one embodiment, the look-a-like service 222 may limit the scoring to those records within a certain, user-selected geography (where the user may, for example, change the target area).

When the processing is done, the “Continue” button on the cloning progress page 1000 is enabled. Clicking the “Continue” button allows the user to go to the checkout process and select how many clones the user wants to purchase and to suppress records that the client already owns. The user does not have to stay on this page to wait until the cloning process is finished. The user may, instead, return to continue later from a dashboard (described in more detail below). The cloning progress page 1000 also gives the user the possibility to cancel the operation, which immediately sends the user back to the previous page.

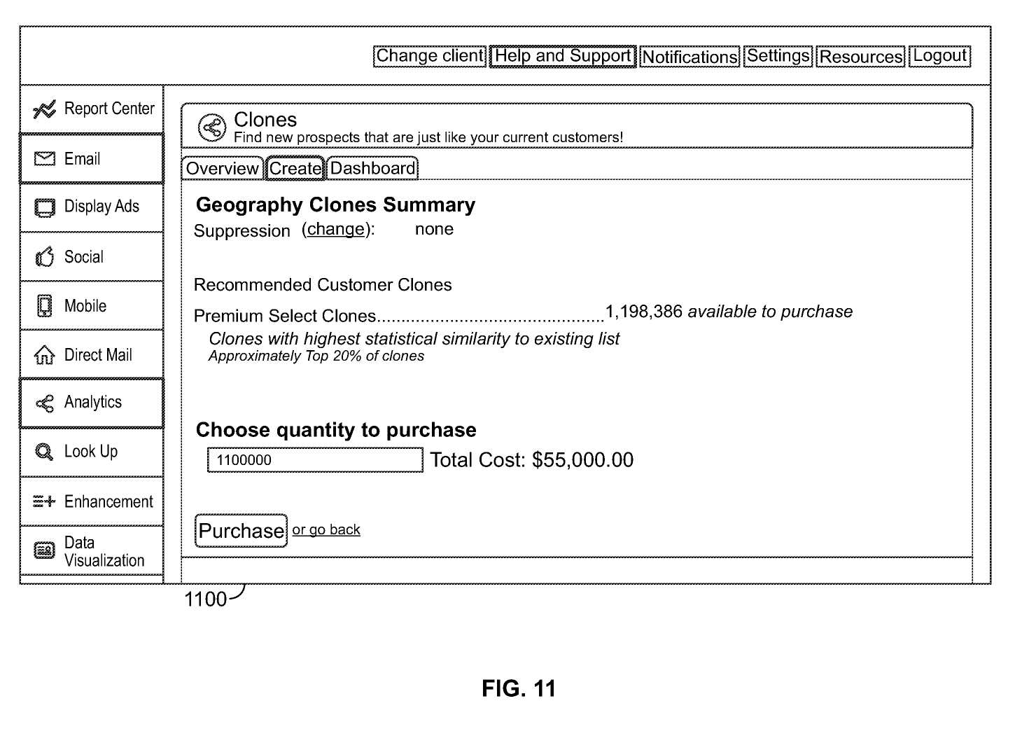

When the user clicks the “Continue” button, in an embodiment, the web application 208 transmits a geography clones summary page to the client device 126, an example of which is shown in FIG. 11. The geography clones summary page 1100 shows the total number of clones generated and allows the user to select how many of them are to be purchased. The price is dynamically calculated as the user types the quantity in the text box.

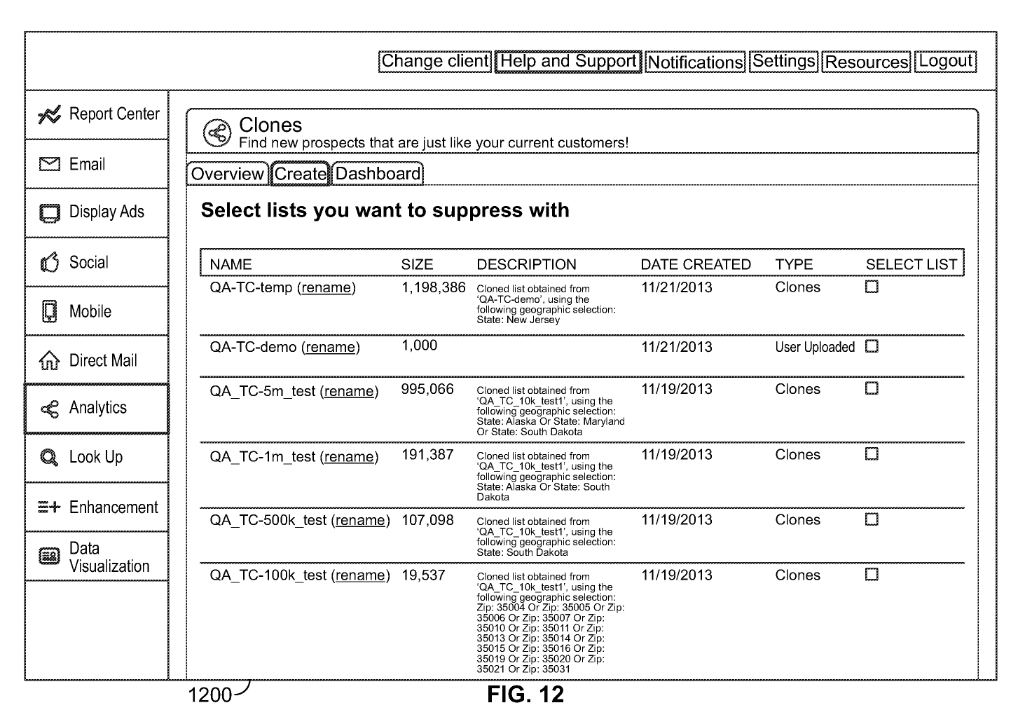

In an embodiment, if the user clicks “Suppression (change)” the web application 208 transmits a list suppression page to the client device 126. An example of a list suppression page is shown in FIG. 12. The list suppression page 1200 allows the user to suppress individual targets (e.g., individual people) before actually making a purchase. The user can select one or more lists and click “OK.” After the suppression is completed, the user is redirected back to the geography clones summary page 1100, to continue the purchase.

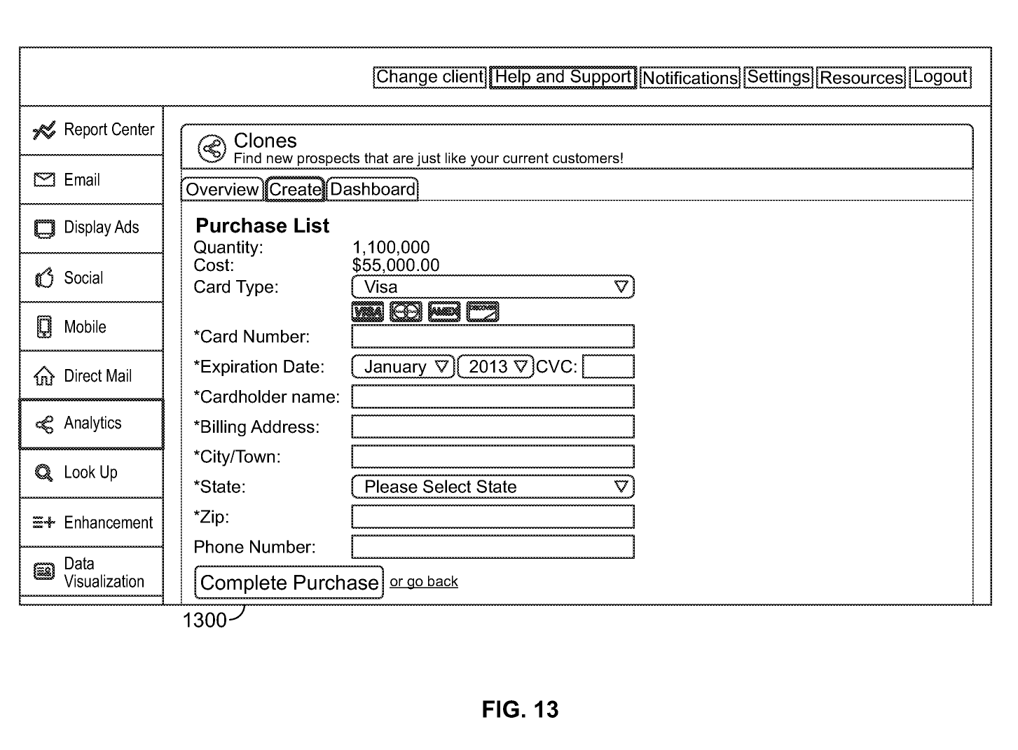

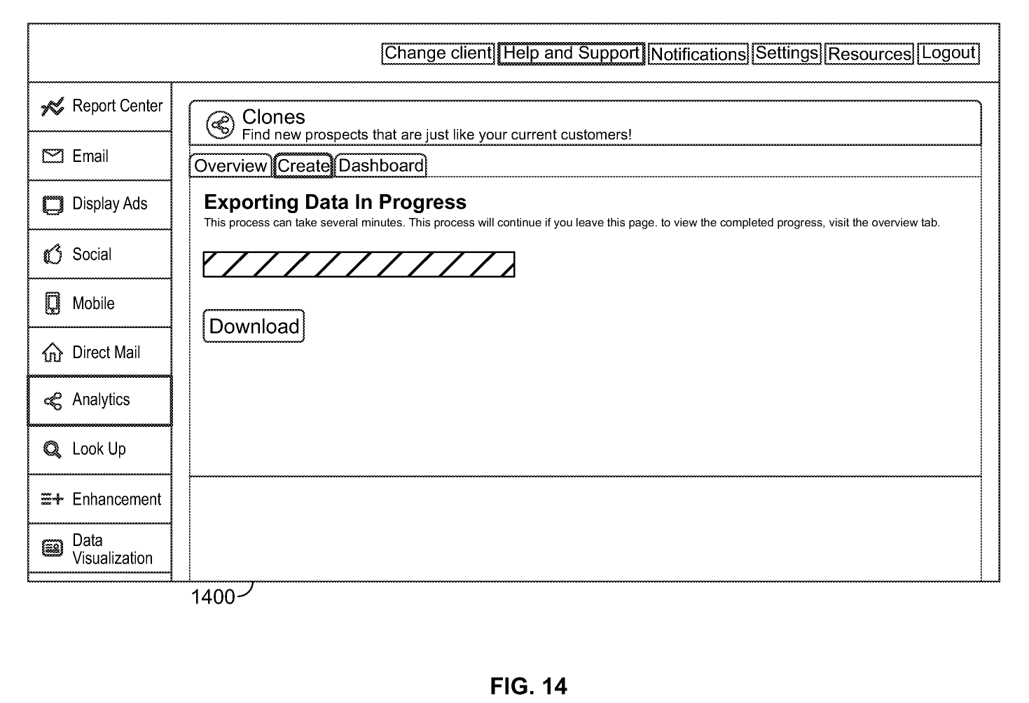

In an embodiment, when the user clicks “Purchase” on the geography clones summary page 1100, the web application 208 transmits a list purchase page to the client device 126, an example of which is shown in FIG. 13. Using the list purchase page 1300, the user can purchase the cloned list. Once the user completes the purchase, the web application 208 calls the delivery service 216 and transmits an export progress page, and example of which is shown on FIG. 14. In an embodiment, the export progress page 1400 displays an indeterminate progress bar, during which the delivery service 216 generates a file that contains the cloned list (e.g., a CSV file) and compresses the file (e.g., creates a .ZIP file). When the delivery service 216 finishes compressing the file, the “Download” button is enabled, and an email notification is sent to the client device 126. The file, which is one of the delivered order files 238, will also be available on the dashboard and on the Order Overview page (discussed in further detail below). The user does not need to stay on this page to wait until the processing is finished. The user may instead return later to find the file ready to be downloaded.

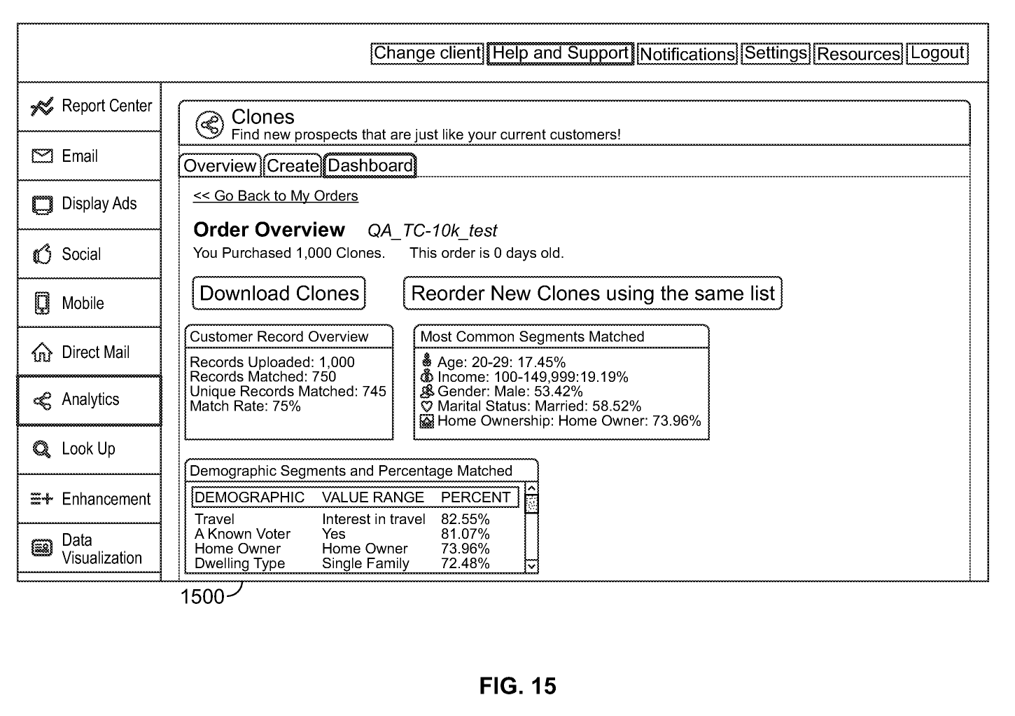

Turning to FIGS. 15, 16, 17, and 18, if the user clicks on the “Dashboard” tab, then the web application 208 transmits various other pages to the client device 126, depending on which other links the user clicks on. On an order overview page 1500, the user can find any of the client's previous orders. From there, the user may click on a link to the details. This page shows the analysis summary of the original list that was used to generate the clones and the number of clones that were ordered. The .ZIP file containing the file with the purchased target list can be re-downloaded from here at any time. In an embodiment, all activity done in the web application 208 can be seen on the dashboard, whenever it is an unfinished draft, a list previously uploaded, or a previous order. The dashboard has a submenu, with three items: My Drafts, My Lists, and My Orders.

If the user wants to generate a new clone list based on the same uploaded list used for this order, the user can click on the “Reorder New Clones using the same list” button. The user will then be sent directly to the geography definition page 900 and will have the opportunity to select a new geographic area and make a new order.

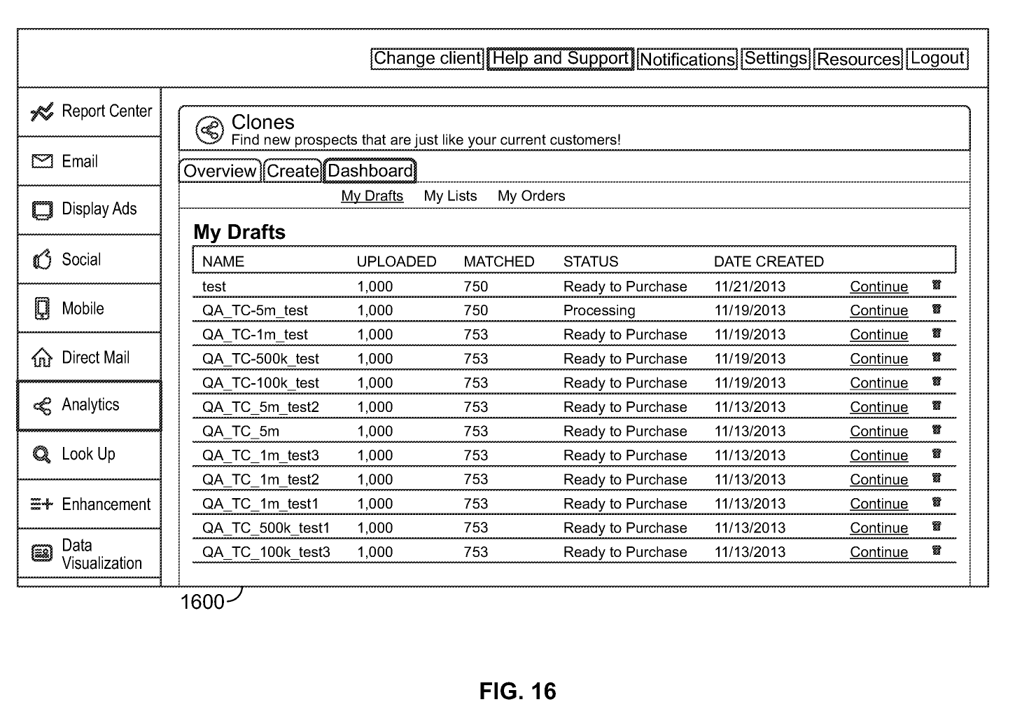

Turning to FIG. 16, in an embodiment, if the customer clicks the “My Drafts” link, the web application 208 transmits a drafts page 1600 to the client device 126. Projects started in the web application 208 are considered drafts up until the moment a purchase is made. Any draft can be continued from the last step the user was on, using the “Continue” link next to it. Next to each draft, there is a delete button (shown in FIG. 16 as a garbage can icon). Pressing it will show a popup with a double confirmation: a checkbox that acknowledges the data will be permanently lost, and a confirm button.

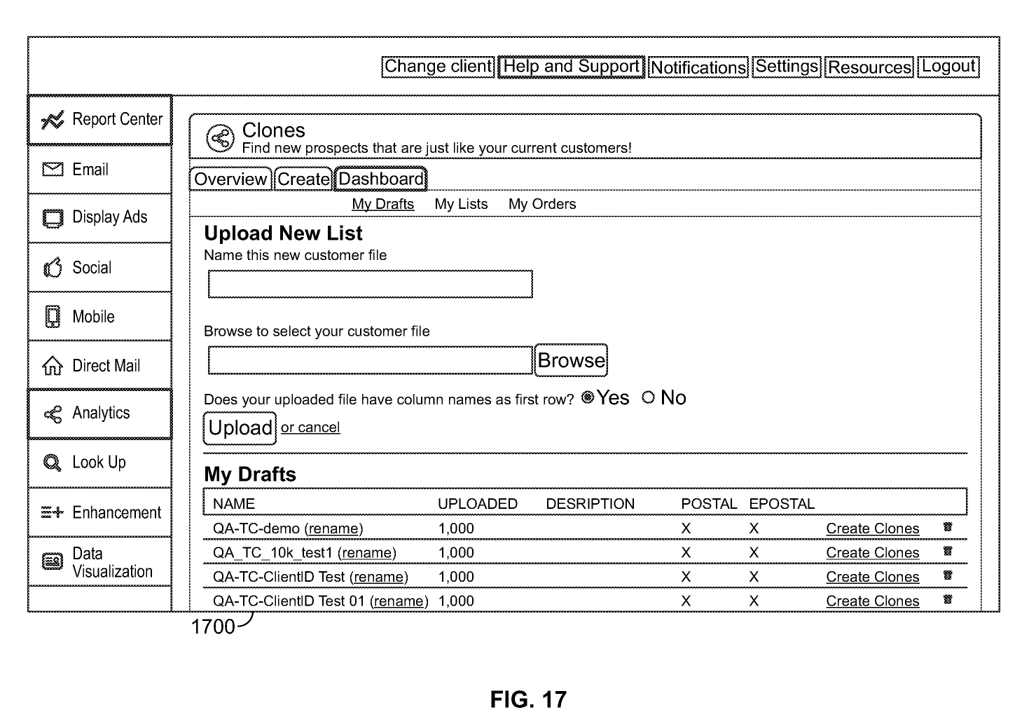

Turning to FIG. 17, in an embodiment, if the customer clicks the “My Lists” link, the web application 208 transmits a lists page 1700 to the client device 126. The lists page 1700 shows the target lists uploaded by the customer. The customer may select a target list and start a clone project based on it. Clicking the “Create Clones” link, will take the customer to the new project page, with this target list already selected. To help the user see what the client can use a list for, there are two columns with checkboxes, one for each type of record. If there is an X in that column, it means the list can be matched against that type of datamart (e.g., postal or e-postal).

The lists page 1700 also allows some basic administration of the target lists. For example, the user can rename lists. If the user clicks on the “(rename)” link next to a list, a popup will appear, asking for a new name. After the rename is complete, a popup message confirming this will appear.

Next to each list, there is a delete button that, if clicked, will result in a popup with a double confirmation: a checkbox that acknowledges the data will be permanently lost, and a confirm button.

Above the grid with the lists, there is an upload control similar to the one on the select page 400, which allows the user to upload a new list with the same mapping flow but without starting a new project. The list will simply be stored for later use.

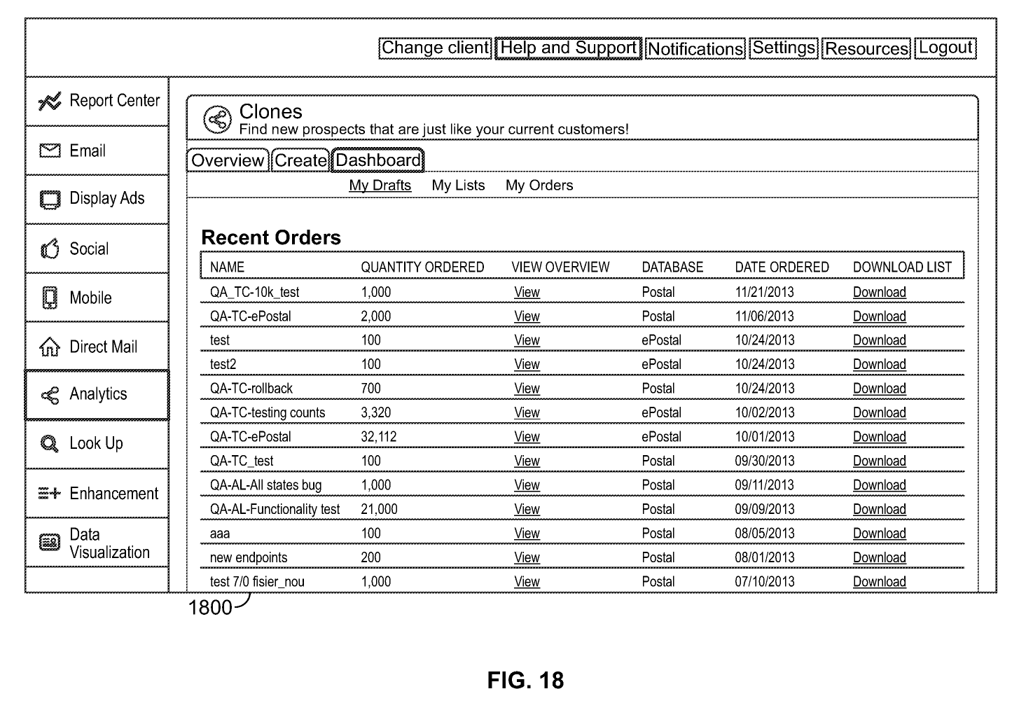

If the user clicks on the “My Orders” link, then the web application 208 transmits a recent orders page to the client device 126. An example of a recent orders page 1800 is shown in FIG. 18. This section of the dashboard shows the client's orders and gives the user an opportunity to download any of the generated files again, as well as to go to an order details page that shows a summary or that order. Unlike the previous dashboard pages, the recent orders page 1800 does not allow the customer to delete anything.

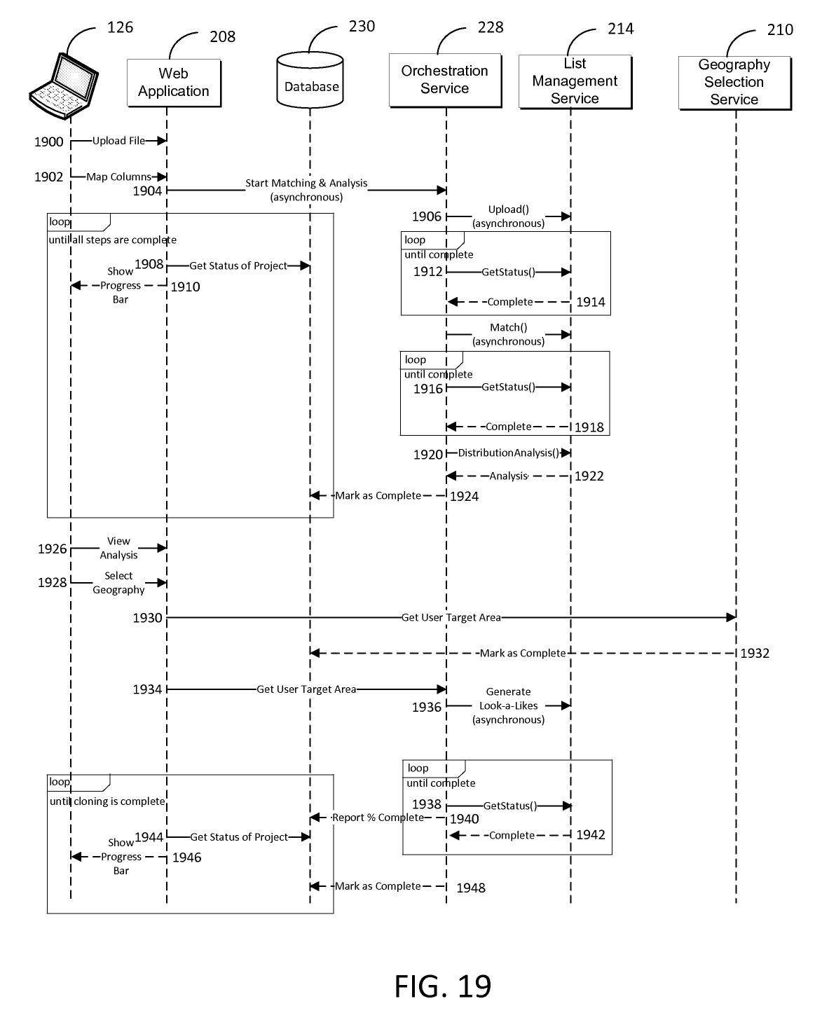

Turning to FIG. 19, a message flow diagram depicts the interaction between various components of FIG. 2 according to an embodiment. At 1900, the client device 126 initiates an upload of a file containing a target list to the web application 208. At 1902, the client device 126 submits column mapping information (e.g., as input by a user) to the web application 208. At 1904, the web application 208 asynchronously sends a message to the orchestration service 228 requesting that the orchestration service 228 start the matching and analysis process. At 1906, the orchestration service 228 asynchronously sends an Upload( )message to the list management service 214 requesting that the list management service 214 handle the file upload that was initiated at 1900. At 1908 and 1910, the web application 208 checks the database 230 (e.g., for the relevant flag) to get the status of the project. Specifically, the web application 208 checks to see whether the upload and the matching processes are complete. The web application 208 also displays a progress bar on the client device 126 at 1910.

At 1912, the orchestration service 228 sends a GetStatus( ) message to the list management service 214 in order to query regarding the progress of the upload. The orchestration service 228 repeats this message until it receives a “Complete” message from the list management service 214 at 1914. At 1916, the orchestration service 228 sends a GetStatus( ) message to the list management service 214 in order to query regarding the progress of the matching process. The orchestration service 228 repeats this message until it receives a “Complete” message from the list management service 214 at 1918. At 1920, the orchestration service 228 sends a DistributionAnalysis( )message to the list management service 214 in order to request that the list management service 214 initiate the preliminary analysis process. When the list management service 214 completes the preliminary analysis process, it messages the orchestration service 228 at 1922 with the results of the analysis. At 1924, the orchestration service 228 marks the analysis process as complete in database 230. The processes 1908 and 1910 are repeated until 1924, at which point the web application 208 discovers that, for example, the relevant flag has been cleared (or set) by the orchestration service 228.

At 1926, the client device 126 (e.g., based on input from the user) submits a request to the web application 208 to view the analysis. At 1928, the client device 126 (e.g., based on input from the user) submits a request to the web application 208 to select the geography. At 1930, the web application 208 sends a message to the geography selection service 210 requesting that a target area selected by the user be used for the purpose of matching. The geography selection service 210 carries this request out and marks the request as complete in the database 230 at 1932. At 1934, the web application 208 sends a message to the orchestration service 228 requesting that the appropriate records (based on the selected datamart and selected target area) be retrieved. At 1936, the orchestration service 228 asynchronously sends a message to the list management service 214 requesting that the list management service 214 generate look-a-likes. The list management service 214 then begins the cloning process.

At 1938, the orchestration service 228 sends a GetStatus( ) message to the list management service 214 in order to query regarding the progress of the look-a-like generation. The orchestration service 228 periodically reports the percentage of the cloned list that has been completed at 1940. The orchestration service 228 repeats the GetStatus( ) message until it receives a “Complete” message from the list management service 214 at 1942, indicating that the cloning process is complete. At 1944, the web application 208 checks the database 230 (e.g., for the relevant flag) to get the status of the cloning process. The web application 208 also displays a progress bar one the client device 126 at 1946. At 1948, the orchestration service 228 marks the analysis process as complete in database 230. The processes 1944 and 1946 are repeated until 1948, at which point the web application 208 discovers that, for example, the relevant flag has been cleared (or set) by the orchestration service 228.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method, on a computing device, for scoring a database, the method comprising:
electronically receiving a plurality of records of a target list from a client;
determining which records of the plurality match records of a database, wherein the records of the database include one or more additional fields that are not contained in the records of the target list;
modeling the relationship among the matched records of the database with respect to the one or more additional fields;
scoring the records of the database based on the additional fields;
based on the scoring, selecting records of database to offer to the client; and
providing the selected records to the client.

2. The method of claim 1, wherein each of the records of the database has a match key, wherein determining which records of the plurality of records of the target list match records of the database comprises:
for each record of the target list,
generating a match key based on the content of a plurality of fields of the record; and
determining, based on the match key of the record of the target list, which record of the database matches the record of the target list.

3. The method of claim 2, further comprising:
using fuzzy logic to assign a numeric value to each field of each record of the database, such that fields of different records having similar but not identical content are assigned the same numeric value.

4. The method of claim 3, further comprising appending the assigned numeric values together to create the match key.

5. The method of claim 1, wherein each record comprises one or more of a name, street address, and email address of a customer of the client.

6. The method of claim 1, wherein the database comprises a plurality of datamarts, each datamart of the plurality comprising records that are appropriate for a particular market segment, the method further comprising receiving a selection of a datamart of the plurality of datamarts, wherein selecting the records comprises selecting the records from the selected datamart.

7. The method of claim 1, wherein scoring the records of the database comprises assigning values, based on the modeling, to a reference table of matched records of the database.

8. The method of claim 1, further comprising assigning, to each record of the target list, the record ID of the record of the database with which the record of the target list was matched.

9. The method of claim 1, further comprising providing a preview of which of a plurality of market segments were determined to have matched records of the database.

10. The method of claim 1, further comprising:
receiving, from the client, a selection of a geography to be used to limit which records are to be offered to the client.

11. The method of claim 1, wherein modeling the relationship among the matched records of the database with respect to the one or more additional fields comprises carrying out a stepwise linear regression process to determine which attributes of potential customers are most likely to result in good clones for the records of the target list.

12. The method of claim 1,
wherein selecting records of the database to offer to the client comprises selecting the records of the database where a score from the scoring exceeds a predetermined percentage, and
wherein providing the selected records to the client comprises electronically transmitting the selected records to the client.

13. A method, on a computing device, for cloning a target list, the method comprising:
electronically receiving a plurality of records of a target list from a client;
for each record of the target list,
generating a match key based on the content of a plurality of fields of the record;
referencing a database comprising a plurality of records, each record having a pre-assigned match key;
determining, based on the match key of the record of the target list, which record of the database matches the record of the target list; and
cloning the records of the target list based on a model developed from the records of the database determined to have matched records of the target list.

14. The method of claim 13, wherein the records of the database include one or more additional fields that are not contained in the records of the target list, the method further comprising:
identifying, based on the model, one or more of the additional fields of the records of the database that are most closely associated with whether or not records of the target list match records of the database;
scoring the records of the database based on the one or more identified fields; and
based on the scoring, selecting records of database to offer to the client; and
electronically transmit the selected records to the client.

15. The method of claim 13, further comprising:
using fuzzy logic to assign a numeric value to each field of each record of the database, such that fields of different records having similar but not identical content are assigned the same numeric value.

16. The method of claim 15, further comprising appending the assigned numeric values together to create the match key.

17. The method of claim 13, wherein each record comprises one or more of a name, street address, and email address of a customer of the client.

18. The method of claim 13, further comprising developing the model by carrying out stepwise linear regression on records of the database determined to have matched records of the target list.

19. A computing device comprising:
a memory having stored therein a database;
a processor configured to:
electronically receive a plurality of records of a target list from a client;
determine which records of the plurality match records of the database, wherein the records of the database include one or more additional fields that are not contained in the records of the target list;
model the relationship among the matched records of the database with respect to the one or more additional fields;
score the records of the database based on the identified fields;
based on the scoring, select records of database to offer to the client, provide the selected records to the client.

20. The computing device of claim 19, wherein the processor is further configured to:
for each record of the target list, generate a match key based on the content of a plurality of fields of the record; and
determine, based on the match key of the record of the target list, which record of the database matches the record of the target list.
